(19) United States
(12) Patent Application Publication
(10) Pub. No.: US 2016/0055320 A1
(43) Pub. Date: Feb. 25, 2016

(54) METHOD AND SYSTEM FOR MEASURING EFFECTIVENESS OF USER TREATMENT

(71) Applicant: Yahoo! Inc., Sunnyvale, CA (US)

(72) Inventors: Pengyuan Wang, Sunnyvale, CA (US); Jian Yang, Palo Alto, CA (US); Marsha Meytlis, Brooklyn, NY (US); Fei Yu, Pittsburgh, PA (US)

(21) Appl. No.: 14/466,470

(22) Filed: Aug. 22, 2014

(51) Int. Cl. G06F 19/00

(52) U.S. Cl. CPC G06F 19/3487; G06F 19/3443

(57) ABSTRACT

Methods, systems and programming for measuring user treatment effectiveness. First information related to activities of each user in a first user set in response to a first treatment is received. Second information related to activities of each user in a second user set in response to a second treatment is received. A model with respect to features is obtained based on the first and second information. Each user is associated with the features. A weighing factor for each user is estimated based on the model and each user's features. A first success rate is computed based on the first information and the weighting factors for each user in the first user set. A second success rate is computed based on the second information and the weighting factors for each user in the second user set. A metric of effectiveness is measured based on the first and second success rates.

### BACKGROUND

1. Technical Field

The present teaching relates to methods, systems, and programming for measuring effectiveness of user treatment.

2. Discussion of Technical Background

As the Internet industry has evolved into an age with diverse user treatment strategies (for example, different advertising formats and delivery channels shown to the users), the market increasingly demands a reliable measurement and a sound comparison of the impact of the different user treatments on user actions (for example, online conversion actions). A metric is needed to show changes in user actions independent of variables that characterize online users. The metric needs to be able to isolate the effect of the user treatments from the effect of other variables.

As an example, the measurement of advertisement (ad) effectiveness is one of the central problems of online advertising. Typically, the performance is measured by investigating the proportion of people who converted or performed other success actions after they saw the ads. These metrics commonly overestimate campaign effectiveness since they do not account for users who would have performed actions even if the campaign did not happen. In other words, confounding effects of the user features, e.g., gender, age, occupation, etc., may become biases in the effectiveness measurement. In order to establish a causal relationship between ad treatments and conversions, such biases from user features need to be eliminated. One known method to obtain the non-biased assessments of the success rates is a randomized experiment, i.e., an A/B test. The success rates of the control and treatment groups are unbiased in an ideal AB test, because the exposed/treated and control users are randomly picked from the same customer and have the same characteristics. However, a randomized test may not always be available, and in an observational advertising campaign, the direct comparison between the treatment and control groups may be biased if control users have different features than the exposed users.

Conventional metrics also do not recognize that the measure of ad effectiveness has multiple dimensions and thus, fail to answer the following questions that are important to advertisers: (1) Which users convert because they see the ad and which users would have converted even if they do not see the ad? (2) What is the cumulative effect of multiple advertising strategies on performance? (3) How does a campaign affect the size of the potential customer pool?

Therefore, there is a need to provide an improved solution for measuring effectiveness of user treatment to solve the above-mentioned problems.

### SUMMARY

The present teaching relates to methods, systems, and programming for measuring effectiveness of user treatment.

In one example, a method, implemented on at least one computing device each having at least one processor, storage, and a communication platform connected to a network for measuring effectiveness of user treatment is presented. First information related to activities of each user in a first user set in response to a first treatment is received. Second information related to activities of each user in a second user set in response to a second treatment is received. A first model with respect to one or more features is obtained based on the first and second information. Each user in the first and second user sets is associated with the one or more features. A weighing factor for each user in the first and second user sets is estimated based on the first model and the one or more features of the respective user. A first success rate of the first user set is computed based, at least in part, on the first information and the weighting factors for each user in the first user set. A second success rate of the second user set is computed based, at least in part, on the second information and the weighting factors for each user in the second user set. A metric of effectiveness of the first treatment compared with the second treatment is measured based on the first and second success rates.

In a different example, a system having at least one processor, storage, and a communication platform for measuring effectiveness of user treatment is presented. The system includes a user activity data collecting module, a model fitting module, a probability estimating module, a success rate computing module, and a metric measuring module. The user activity data collecting module is configured to receive first information related to activities of each user in a first user set in response to a first treatment and second information related to activities of each user in a second user set in response to a second treatment. The model fitting module is configured to obtain a first model with respect to one or more features based on the first and second information. Each user in the first and second user sets is associated with the one or more features. The probability estimating module is configured to estimate a weighing factor for each user in the first and second user sets based on the first model and the one or more features of the respective user. The success rate computing module is configured to compute a first success rate of the first user set based, at least in part, on the first information and the weighting factors for each user in the first user set and a second success rate of the second user set based, at least in part, on the second information and the weighting factors for each user in the second user set. The metric measuring module is configured to measure a metric of effectiveness of the first treatment compared with the second treatment based on the first and second success rates.

Other concepts relate to software for measuring effectiveness of user treatment. A software product, in accord with this concept, includes at least one non-transitory machine-readable medium and information carried by the medium. The information carried by the medium may be executable program code data regarding parameters in association with a request or operational parameters, such as information related to a user, a request, or a social group, etc.

In one example, a non-transitory machine readable medium having information recorded thereon for measuring effectiveness of user treatment is presented. The recorded information, when read by the machine, causes the machine to perform a series of processes. First information related to activities of each user in a first user set in response to a first treatment is received. Second information related to activities of each user in a second user set in response to a second treatment is received. A first model with respect to one or more features is obtained based on the first and second information. Each user in the first and second user sets is associated with the one or more features. A weighing factor for each user in the first and second user sets is estimated based on the first model and the one or more features of the respective user. A first success rate of the first user set is computed based, at least in part, on the first information and the weighting factors for each user in the first user set. A second success rate of the second user set is computed based, at least in part, on the second information and the weighting factors for each user in the second user set. A metric of effectiveness of the first treatment compared with the second treatment is measured based on the first and second success rates.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts confounding effect of user features as bias in finding the real causal impact of ads on conversions;

FIG. 2 is an exemplary illustration of measuring the uplift effect of user treatment, according to an embodiment of the present teaching;

FIG. 3 is an exemplary illustration of measuring the synergy effect of user treatment, according to an embodiment of the present teaching;

FIG. 4 is an exemplary illustration of measuring the customer pool expansion effect of user treatment, according to an embodiment of the present teaching;

FIG. 5 is an exemplary system diagram of a system for measuring user treatment effectiveness, according to an embodiment of the present teaching;

FIG. 6 is an exemplary system diagram of a use treatment effectiveness measurement engine in the system in FIG. 5, according to an embodiment of the present teaching;

FIG. 7 is a flowchart of an exemplary process for effectiveness metric measurement with weighing and adjusting factors, according to an embodiment of the present teaching;

FIG. 8 is an exemplary diagram of parallel computing with subsampling in measuring user treatment effectiveness, according to an embodiment of the present teaching;

FIG. 9 is a flowchart of an exemplary process for parallel computing with subsampling in measuring user treatment effectiveness, according to an embodiment of the present teaching;

FIG. 10 depicts exemplary receiver operating characteristic (ROC) curves with and without subsampling;

FIG. 11 depicts exemplary histograms showing the treatment effect measurement for simulated datasets;

FIG. 12 depicts exemplary histograms showing the network activities changes before and after the weighting for the control and treatment groups;

FIG. 13 depicts exemplary histograms showing the auto purchase intention changes before and after the weighting for the control and treatment groups;

FIG. 14 depicts exemplary histograms showing the uplift, synergy, and customer pool expansion effects;

FIG. 15 depicts exemplary plots showing success olds along with probability belonging to the corresponding Internet provider group;

FIG. 16 depicts exemplary plots showing success olds along with probability belonging to the corresponding phone system group;

FIG. 17 is a high level exemplary networked environment in which user treatment effectiveness measurement is applied, according to an embodiment of the present teaching; and

FIG. 18 depicts a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

Throughout the specification and claims, terms may have nuanced meanings suggested or implied in context beyond an explicitly stated meaning. Likewise, the phrase “in one embodiment/example” as used herein does not necessarily refer to the same embodiment and the phrase “in another embodiment/example” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present teaching describes methods, systems, and programming aspects of user treatment effectiveness measurement. The method and system in the present teaching implement a unified causal modeling framework that establishes a causal relationship between user treatments and performing an action, which is based on propensity methodology embedded, for example, in a parallel computation algorithm. The method and system are suitable for working with observational data and do not require randomization. The method and system in the present teaching also implement a novel robust rank test for model validation and provide innovative interpretations of the measurement results by causal inference from different dimensions, e.g., uplift, synergy, and customer pool expansion effects. The three components (model, validation, and interpretation) complete a unified solution to online user treatment effect measurement. Results from real online data show that method and system are robust to online data sparseness, high dimensionality, and biases from user features. Moreover, the method and system in the present teaching may be readily applicable to various cases, for example, to measure the impact of online ads on user conversion, or to measure the impact of various strategies on user engagement metrics.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

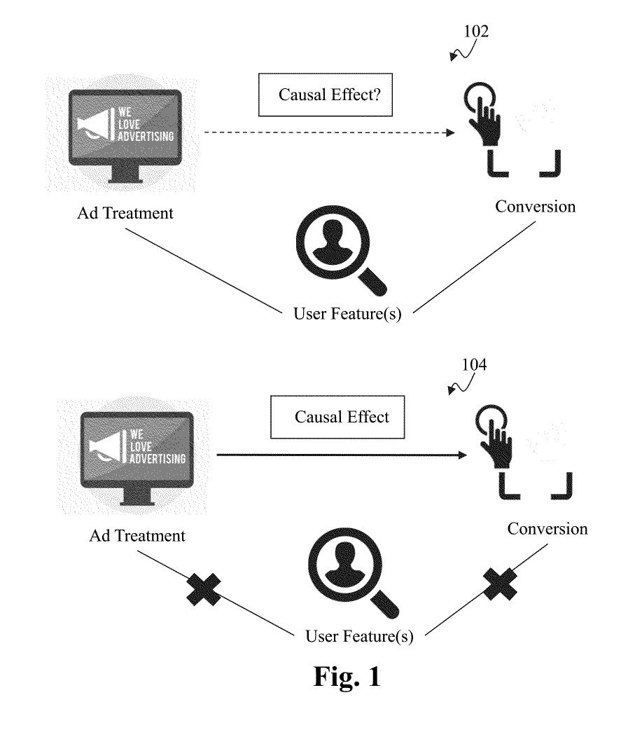

FIG. 1 depicts confounding effect of user features as bias in finding the real causal impact of ads on conversions. Evaluating the actual causal effect between ads exposure/treatment and user conversion is one of the examples of user treatment effectiveness measurement. A success or conversion performance may be an action favored by the ad campaign, such as click, search or site visitation. Success rate is the percentage of unique users who take a success action. In the present teaching, “success” and “conversion” are used interchangeably, and “treatment” and “exposure”/“exposed” are used interchangeably. In an observational advertising campaign, the direct comparison between exposed and control user groups may be biased if control users have different features than the exposed users. In one example of a cosmetic product campaign where all of exposed users are females and all of the control users are males. If the females generally have a larger conversion rate than males, the effectiveness of the campaign could be overestimated because of the confounding effect of the user features, in this case, gender. In such cases, the high success rate of the exposed group is not caused by ads, and hence cannot serve as a fair measurement of ad effectiveness. In order to establish a causal relationship between ad treatment and conversion, such bias from user features need to be eliminated. The intuition behind this argument is illustrated as in 102, where the ad effect on conversion is confounded by user features. One needs to eliminate the impact of user features as shown in 104 to isolate the real causal impact of ads on conversions.

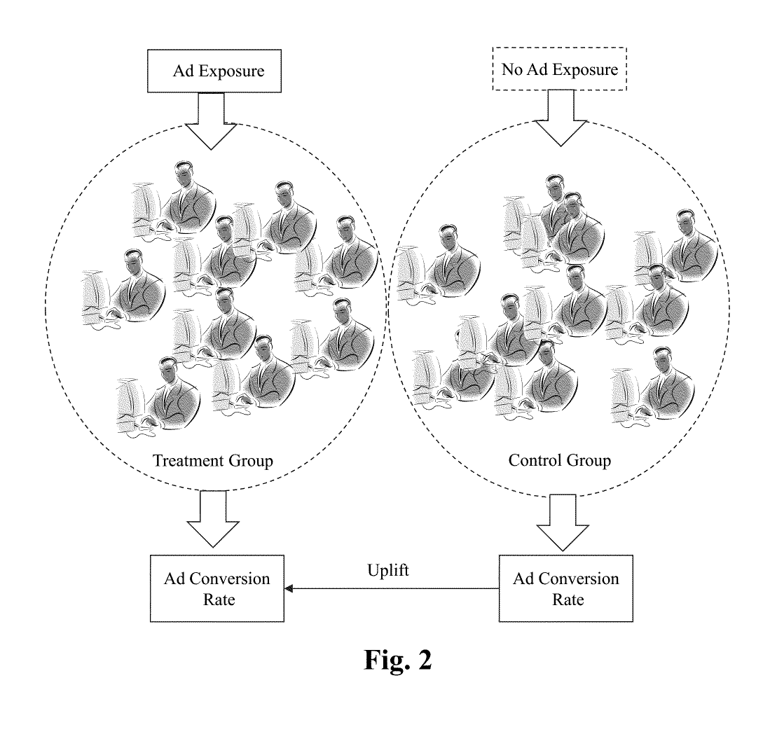

Based on models that eliminate the impact of user features and suitable of observational data, the method and system in the present teaching introduce various novel metrics for measuring user treatment effectiveness. Taking ads campaign performance evaluation as an example, the method and systems in the present teachings evaluate three dimensions: (1) uplift, i.e., the direct effect of a single advertising strategy on user performance; (2) synergy, i.e., the effect of multiple advertising strategies on user performance, and (3) customer pool expansion, i.e., the effect of ad campaign on customer pool expansion. FIGS. 2-4 are exemplary illustrations of measuring the uplift, synergy, and customer pool expansion effects of user treatment, according to various embodiments of the present teaching.

As shown in FIG. 2, uplift is a metric that measures the effectiveness of a single ad placement. The treatment group in this example includes users who have been exposed by a single ad, while the control group includes users who have not been exposed by that particular ad. The ad conversion rates for each of the treatment and control groups are computed, and their ratio and/or difference are used as the value of uplift metric. For example, uplift is a metric that measures change in online brand interest that results from additional users who are recruited by a campaign. Users who perform regardless of whether they see an ad need to be discounted, which requires unbiased estimations of the portion of users who will convert without ad exposure.

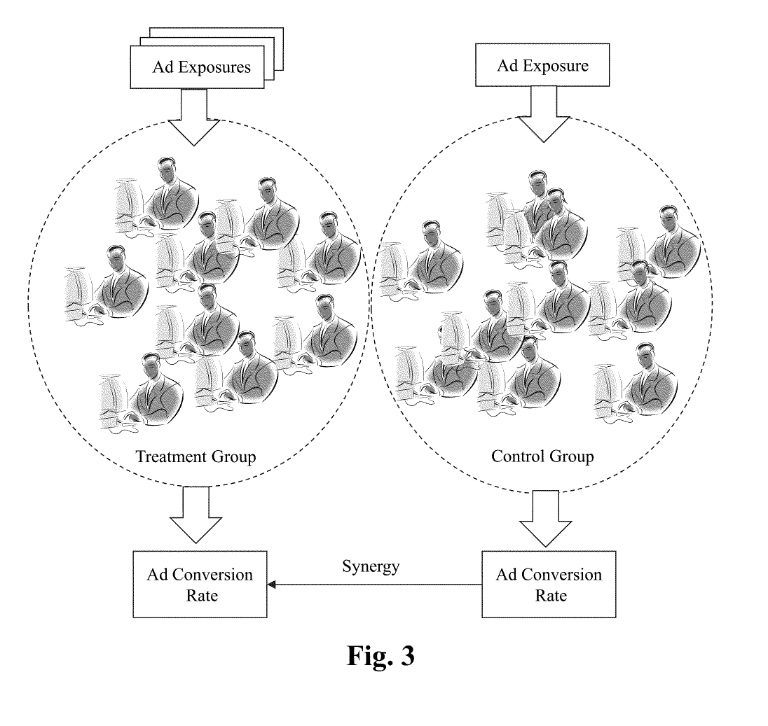

As shown in FIG. 3, synergy is a metric that measures the cumulative effect of multiple campaigns on user performance. Frequently, an advertiser may run several campaigns simultaneously, such as a website takeover and a mobile campaign, or a video campaign and a direct response campaign. The advertiser needs to not only know the uplift of each individual campaign, but also how each of these campaigns enhances one another. The treatment group in this example includes users who have been exposed to multiple ad campaigns, while the control group includes users who have been exposed by only some of the ads campaigns. The ad conversion rates for each of the treatment and control groups are computed, and their ratio and/or difference are used as the value of the synergy metric.

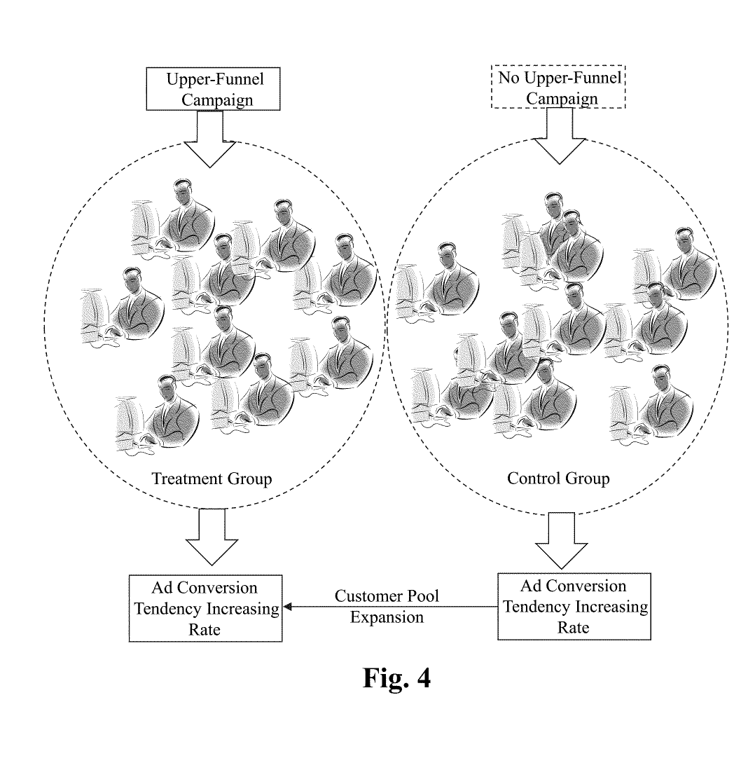

As shown in FIG. 4, the third metric is to determine how the potential customer pool changes as a result of the ad campaign. For example, typically customers need to show brand awareness before they are ready to make a commitment to purchase a product. This process of learning about a product and then deciding to buy the product is referred to as traveling down the purchase funnel. In one example, an ad campaign may have an upper-funnel campaign (for example, a campaign for branding) and a lower-funnel campaign (for example, a banner ad campaign which wants customers to get a quote). The upper-funnel campaign expands the audience pool of the lower-funnel campaign. The customer pool expansion metric gives insight on, for example, how many new users have entered the purchase funnel because of learning about the product in a branding ad campaign. The treatment group in this example includes users who have been exposed by a upper-funnel campaign, while the control group includes users who have not been exposed by the upper-funnel campaign. The success indicator is whether or not this person is targeted by the lower-funnel campaign. The ad conversion tendency increasing rates for each of the treatment and control groups are computed, and their ratio and/or difference are used as the value of the customer pool expansion metric.

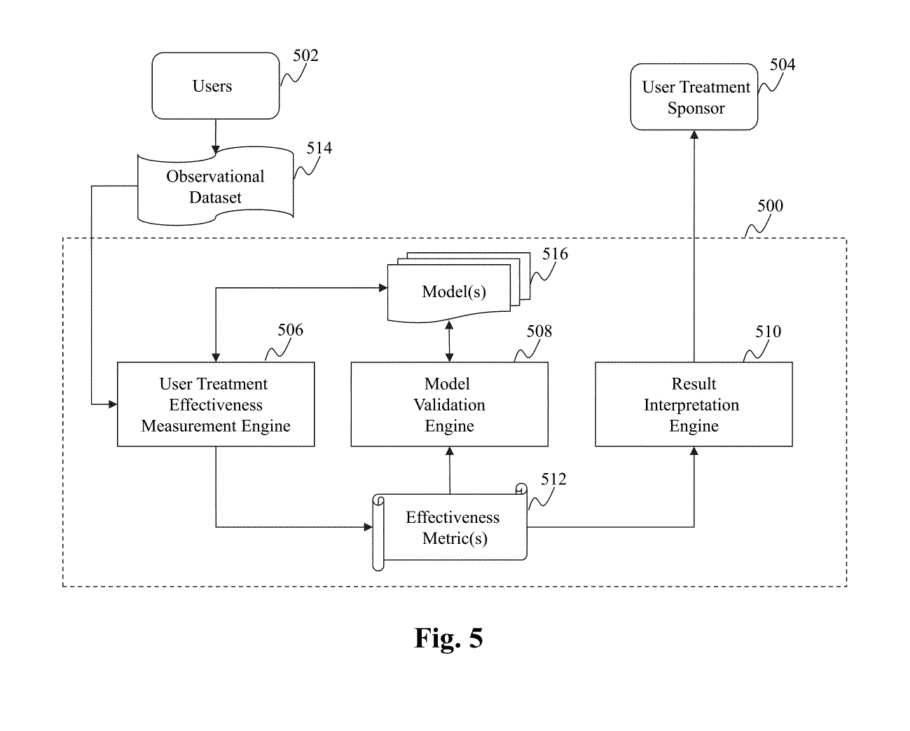

FIG. 5 is an exemplary system diagram of a system for measuring user treatment effectiveness, according to an embodiment of the present teaching. The system 500 in this example measures the effectiveness of various types of treatments applied to users 502, e.g., the impact of ads on user conversion actions, or impact of various strategies on user engagement metrics, and also provides the results to user treatment sponsors 504, e.g., advertisers, publishers, merchandises, or personalized content providers, as feedback of the treatment effects. In this embodiment, the system 500 includes a user treatment effectiveness measurement engine 506, a model validation engine 508, and a result interpretation engine 510. The user treatment effectiveness measurement engine 506 is configured to measure effectiveness metric(s) 512 of certain user treatment based on observational dataset 514 using model(s) 516 that eliminate the bias from user features. For example, the user treatment effectiveness measurement engine 506 may apply a propensity-based causal inference framework to address the sparsity and huge volume in industrial observational datasets. In one example, the models 516 include a causal model that balances the user features of the exposed and control groups, and hence establishes a cause and effect relationship between seeing an ad and performing actions. The causal model enables the measurements of the three aspects of ad effectiveness (uplift, synergy, and customer pool expansion) in a unified framework. The details of the user treatment effectiveness measurement engine 506 are described later.

In this embodiment, the model validation engine 508 is configured to validate the model(s) 516 used by the user treatment effectiveness measurement engine 506. In one example, the model validation engine 508 may check whether a propensity-based weighting model has balanced the control and exposed groups based on the effectiveness metrics 512 computed by the user treatment effectiveness measurement engine 506. To address the non-robustness in the model verification of the traditional methods, the model validation engine 508 implements a novel robust rank test for user features covariate balancing verification, which is suitable for addressing, for example, the skewness of advertising data with a robust weighted rank test. In this embodiment, the model validation engine 508 may validate the models 516 in three ways. First, the model validation engine 508 may conduct basic validation to check the weights and effective sample sizes of the weighted groups. Second, the model validation engine 508 may verify the balancing effect of the propensity-based weighting, with the robust rank test. Third, the model validation engine 508 may conduct an irrelevant conversion test to validate the unbiasedness of the models 516. The details of the model validation engine 508 are described later.

In this embodiment, the result interpretation engine 510 is configured to interpret the effectiveness metrics 512 computed by the user treatment effectiveness measurement engine 506 and provide the interpretation to the corresponding user treatment sponsors 504. That is, the effectiveness metrics 512 merely shows the values of change in ad conversation ratio/difference between treatment and control groups, which may require further interpretation from business point of view. For example, a major concern for online advertising is that, some of the users might convert even without any ad exposure. Targeting on this part of users might result in high conversion rates but actually does not add to the value of the advertisers. The result interpretation engine 510 devises a strategy to interpret the calculated effectiveness metrics 512, which reveals the “smart cheating” or the “honest reaching” in ad placements.

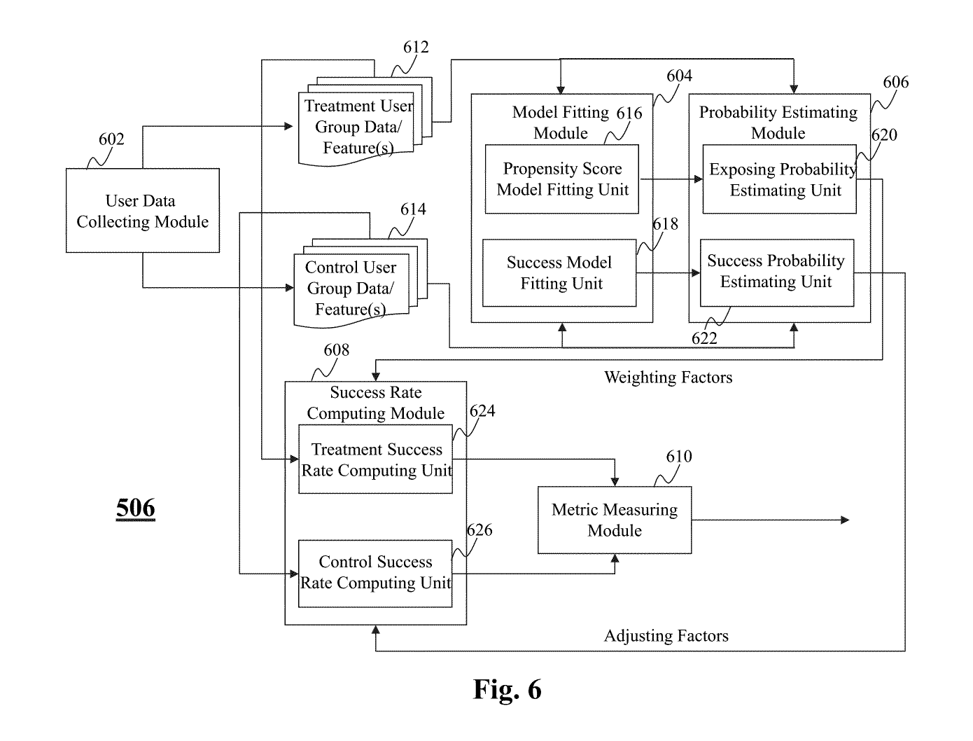

FIG. 6 is an exemplary system diagram of a use treatment effectiveness measurement engine in the system 500 of FIG. 5, according to an embodiment of the present teaching. The user treatment effectiveness measurement engine 506 in this embodiment includes a user data collecting module 602, a model fitting module 604, a probability estimating module 606, a success rate computing module 608, and a metric measuring module 610. The user data collecting module 602 is responsible for receiving information related to activities of users in treatment and control groups in response to exposed treatment and controlled treatment, respectively. The user data collecting module 602 may collect user activities information from the observational datasets 514, such as online ad campaign dataset. In this embodiment, the user data collecting module 602 receives both treatment user group data/features 612 and control user group data/features 614. If the specific effectiveness metric of interest is the uplift effect or customer pool expansion effect, then the treatment user group data includes activities of each user in the treatment group in response to a single ad exposure, and the control user group data includes activities of each user without being exposed to the ad. If the specific effectiveness metric of interest is the synergy effect, then the treatment user group data includes activities of each user in the treatment user set in response to multiple ad exposures, and the control user group data includes activities of each user in response to only one or some of the ad exposures. The user activities may include, for example, user ad conversion actions, e.g., clicking an ad, searching a promoted product, visiting the advertiser's website, or other user engagement actions, e.g., clicking or dwelling on a content item. For customer pool expansion effect measurement, the user activities may further include any user activities associated with a tendency towards ad conversion, even though the actual ad conversion has not occurred yet.

In this embodiment, not only user activities information is collected by the user data collecting module 602, in order to eliminate the bias caused by user features, certain user features associated with each user in the treatment and control groups are also obtained by the user data collecting module 602 as part of the treatment user group data/features 612 and control user group data/features 614. The user features include for example, demographics, such as age, gender, race, occupation, location, family size, etc., user interests, site visitations, and ad impressions. The user features may be preselected or dynamically selected in real time based on their degrees of effect with respect to each user treatment by a feature selection step using, for example, gradient boosting stumps. For example, for a cosmetic product ad campaign, gender and age are well recognized user features that introduce bias to the effectiveness measurement and thus are preselected user features to be collected from each user in the treatment and control groups. Any other user features, if they are found as affecting the conversion of the specific cosmetic product, may be also included in the treatment user group data/features 612 and control user group data/features 614 and taken into consideration in future analysis.

The model fitting module 604 in this embodiment is configured to obtain model(s) with respect to the user features based on the received treatment user group data/features 612 and control user group data/features 614. In this example, the model fitting module 604 includes a propensity score model fitting unit 616 for fitting a propensity score model and a success model fitting unit 618 for fitting a success model. The probability estimating module 606 in this embodiment includes an exposing probability estimating unit 620 configured to estimate a weighing factor for each user in the treatment and control user sets based on the propensity score model and the features of the respective user. The weighting factor relates to probability of exposing the respective user to the exposed treatment applied to the treatment group (e.g., ad exposure in the uplift measurement or multiple ad exposures in the synergy measurement) with respect to the user features. The probability estimating module 606 in this embodiment may further include a success probability estimating unit 622 configured to estimate an adjusting factor for each user in the treatment and control user sets based on the success model and the features of the respective user. The adjusting factor relates to probability of performing an effective activity, e.g., user ad conversion actions, user activities associated with a tendency towards ad conversion, or other user engagement actions, by the respective user with respect to the user features.

In one example, the propensity score model is based on the inverse propensity weighting (IPW) approach. Defining propensity score as the probability \hat{p}ᵢ=P(zᵢ=I(Xᵢ), ∀i, whose estimated probability \hat{p}ᵢ is obtained by fitting the propensity score model \hat{P}_{(X)} to estimate probability to be exposed with respect to the user feature covariate X. For example, \hat{p}ᵢ˜\hat{P}(Xᵢ) is modeled where zᵢ=1 with probability \hat{p}ᵢ. The basic idea is to use the estimated \hat{p}ᵢ to match the treatment and control groups, rather than to match the multiple dimensional user features X. In this example, for each user feature X, a weighting factor of 1/(1−\hat{p}ᵢ) is assigned to each user in the control group, and a weighting factor of 1/\hat{p}ᵢ is assigned to each user in the treatment group. The rationale behind these weighting factors is that a user in the treatment group belongs to its group with the probability of \hat{p}ᵢ, and a user in the control group belongs to its group with the probability of 1−\hat{p}ᵢ. Hence each is weighted by the inverse of this probability to infer the situation of the population.

Various approaches may be applied by the propensity score model fitting unit 616 to fit the propensity score model to estimate the probability \hat{p}ᵢ for each user with respect to each user feature X. In this example, gradient boosting tree (GBT) is used to model the propensity score model \hat{P}_{(X)}. Additionally or optionally, GBT approach may be combined with a feature selection step using gradient boosting stumps to automatically pick up user features that have impact/bias on the causal inference and to estimate the probability \hat{p}ᵢ with respect to each of the selected user features. For example, all user features with non-zero influence determined by the gradient boosting stumps approach may be chosen. In addition to GBT, any other suitable approaches known in the art may be applied as well, such as principal component analysis (PCA) for feature selection, and logistic regression, Lasso, and random forest for modeling with selected features. Once the propensity score model \hat{P}(x) is fitted, the exposing probability estimating unit 620 estimates the weighting factors for each user in the treatment and control groups with respect to each selected user feature. As described above, in this example, a weighting factor of 1/(1−\hat{p}ᵢ) is assigned to each user in the control group, and a weighting factor of 1/\hat{p}ᵢ is assigned to each user in the treatment group.

In addition to the weighting factors that compensate for the bias caused by user features, adjusting factors based on estimation of the probability to success under exposure and control treatments respectively may be applied to further improve the robustness, i.e., smaller variance, of the user treatment effectiveness measurement engine 506. In one example, doubly robust (DR) estimation approach is applied to fit the success model \hat{M}_{0(X)} and \hat{M}_{1(X)} to estimate probability to convert with respect to the user feature covariate X under control and exposed treatments respectively, where each user's success probabilities under exposed and control conditions are \hat{m}₁ᵢ and \hat{m}₀ᵢ. For example, \hat{M}₁ may be fitted with the observed treatment user group data/features 612, where \hat{m}₁ᵢ˜\hat{M}_{1(Xi)}, and yᵢ=1 with probability \hat{m}₁ᵢ. Here, the success metric (such as conversion) is indicated by yᵢ=1 (success) or 0 (un-success), and i=1, 2, . . . , N is for users. The model \hat{M}₀ may be fitted similarly with the control user group data/features 614. As described above, the fitting of the success models \hat{M}₀ and \hat{M}₁ may be performed by the success model fitting unit 618 using GBT with feature selection or any other suitable approaches, such as PCA for feature selection, and logistic regression, Lasso, or random forest for modeling with selected features. In this embodiment, the adjusting factor −\hat{m}₁ᵢ(zᵢ−\hat{p}ᵢ) is assigned to each user in the treatment group with respect to each selected user feature, and the adjusting factor \hat{m}₀ᵢ(zᵢ−\hat{p}ᵢ) is assigned to each user in the control group with respect to each selected user feature. Based on the models fitted by the success model fitting unit 618, the success probability estimating unit 622 provides the adjusting factors for each user with respect to each of the selected user features.

The success rate computing module 608 in this embodiment includes a treatment success rate computing unit 624 and a control success rate computing unit 626. The treatment success rate computing unit 624 is configured to compute a success rate of the treatment user set based on the treatment user group data/features 612 and the weighting factors and/or the adjusting factors for each user in the treatment user set. Similarly, the control success rate computing unit 626 is configured to compute a success rate of the control user set based on the control user group data/features 614 and the weighting factors and/or the adjusting factors for each user in the control user set. The naive way to calculate the average success rates of the exposed and control groups, respectively, are shown as:

$$\begin{matrix}{r}_{naive , exposed} = \frac{1}{{\sum }_{i} {z}_{i}} {\sum }_{i} {z}_{i} {y}_{i} ; & ( 1 ) \\ {r}_{naive , control} = \frac{1}{{\sum }_{i} ( 1 - {z}_{i} )} {\sum }_{i} ( 1 - {z}_{i} ) {y}_{i} . & ( 2 )\end{matrix}$$

In the example where weighting factors are estimated based on the IPW approach, the naive success rates in Equations (1) and (2) are weighted by the weighting factors as:

$$\begin{matrix}{r}_{ipw , exposed} = \frac{1}{N} {\sum }_{i} {z}_{i} {y}_{i} / {\hat{p}}_{i} , & ( 3 ) \\ {r}_{ipw , control} = \frac{1}{N} {\sum }_{i} ( 1 - {z}_{i} ) {y}_{i} / ( 1 - {\hat{p}}_{i} ) . & ( 4 )\end{matrix}$$

The above weighted success rates measure the average exposure effect over the whole population. In some examples, the average exposure effect on the subpopulation of users who actually got exposed may be of interest, which is called the treatment on treated effect (TTE). For this calculation, users in the control group are weighted by \hat{p}ᵢ/(1−\hat{p}ᵢ) and users in the treatment group are not weighted, as shown below:

$$\begin{matrix}{r}_{ipw , tte , exposed} = \frac{1}{{\sum }_{i} {z}_{i}} {\sum }_{i} {z}_{i} {y}_{i} , & ( 5 ) \\ {r}_{ipw , tte , control} = \frac{1}{{\sum }_{i} ( 1 - {z}_{i} ) {\hat{p}}_{i} \vert / ( 1 - {\hat{p}}_{i} )} {\sum }_{i} ( 1 - {z}_{i} ) {y}_{i} {\hat{p}}_{i} / ( 1 - {\hat{p}}_{i} ) . & ( 6 )\end{matrix}$$

In this example, additionally or optionally, adjusting factors estimated by the success probability estimating unit 622 may be used by the success rate computing module 608 to improve the robustness of the results. Defining δ_{i,exposed} amd δ_{i,control} as the adjusted observations augmented with the adjusting factors −\hat{m}₁ᵢ(zᵢ−\hat{p}ᵢ) and \hat{m}₀ᵢ(zᵢ−\hat{p}ᵢ), and then r_{dr,exposed} and r_{dr,control} are the adjusted calculation of the success rate of the exposed and control groups, respectively, as below:

$$\begin{matrix}{δ}_{i , exposed} = \frac{{z}_{i} {y}_{i} - {\hat{m}}_{1 i} ( {z}_{i} - {\hat{p}}_{i} )}{{\hat{p}}_{i}} , & ( 7 ) \\ {δ}_{i , control} = \frac{( 1 - {z}_{i} ) {y}_{i} + {\hat{m}}_{0 i} ( {z}_{i} - {\hat{p}}_{i} )}{1 - {\hat{p}}_{i}} , & ( 8 ) \\ {r}_{dr , exposed} = \frac{1}{N} {\sum }_{i} {δ}_{i , exposed} , & ( 9 ) \\ {r}_{dr , control} = \frac{1}{N} {\sum }_{i} {δ}_{i , control} . & ( 10 )\end{matrix}$$

The TTE may be calculated similarly:

$$\begin{matrix}{r}_{dr , exposed , tte} = \frac{1}{{\sum }_{i} {\hat{p}}_{i}} {\sum }_{i} {δ}_{i , exposed} {\hat{p}}_{i} ; & ( 11 ) \\ {r}_{dr , control , tte} = \frac{1}{{\sum }_{i} {\hat{p}}_{i}} {\sum }_{i} {δ}_{i , control} {\hat{p}}_{i} . & ( 12 )\end{matrix}$$

The metric measuring module 610 in this embodiment is configured to measure a metric of effectiveness of the exposure treatment compared with the control treatment based on the respective success rates. The effectiveness metrics may include the difference between the success rate of the treatment group and the success rate of the control group and the ratio (amplifier) of the success rate of the treatment group over the success rate of the control group.

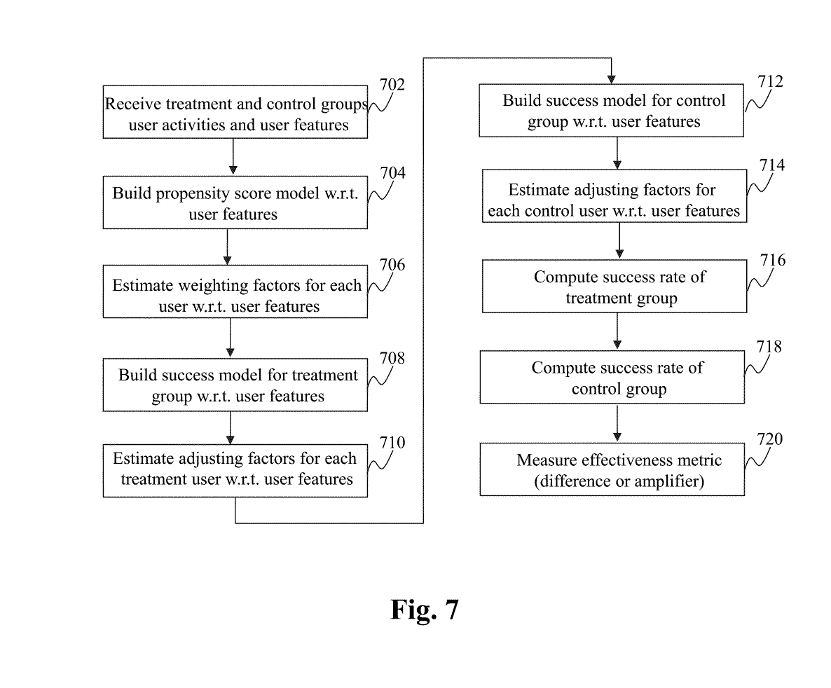

FIG. 7 is a flowchart of an exemplary process for effectiveness metric measurement with weighing and adjusting factors, according to an embodiment of the present teaching. Starting at 702, information related to user activities and user features of each user in both the treatment and control groups is received. The information may be observational dataset without randomization. At 704, a propensity score model with respect to each of the user features that has non-zero influence on causal inference is built. The model may be fitted by GBT approach with a feature selection step using gradient boosting stumps. At 706, weighting factors for each user in the control and treatment groups are estimated with respect to each selected user feature. For example, IPW approach may be applied to estimate the weighting factors based on the propensity score model. At 708, a success model for treatment user group with respect to each selected user feature is built. Similarly, the model may be fitted by GBT approach with a feature selection step using gradient boosting stumps. At 710, adjusting factors for each user in the treatment group are estimated with respect to each selected user feature. At 712, another success model for control user group with respect to each selected user feature is built. At 714, adjusting factors for each user in the control group are estimated with respect to each selected user feature. The adjusting factors may be estimated based on the DR estimation approach. Moving to 716, success rate of the treatment group is computed based on the treatment user dataset, which is weighted by the corresponding weighting factors and/or adjusted by the corresponding adjusting factors. At 718, success rate of the control group is computed based on the control user dataset, which is weighted by the corresponding weighting factors and/or adjusted by the corresponding adjusting factors. Eventually, at 720, effectiveness metrics of the user treatment are measured, which may be the difference between the success rates computed at 716 and 718 or the ratio/amplifier of the two success rates.

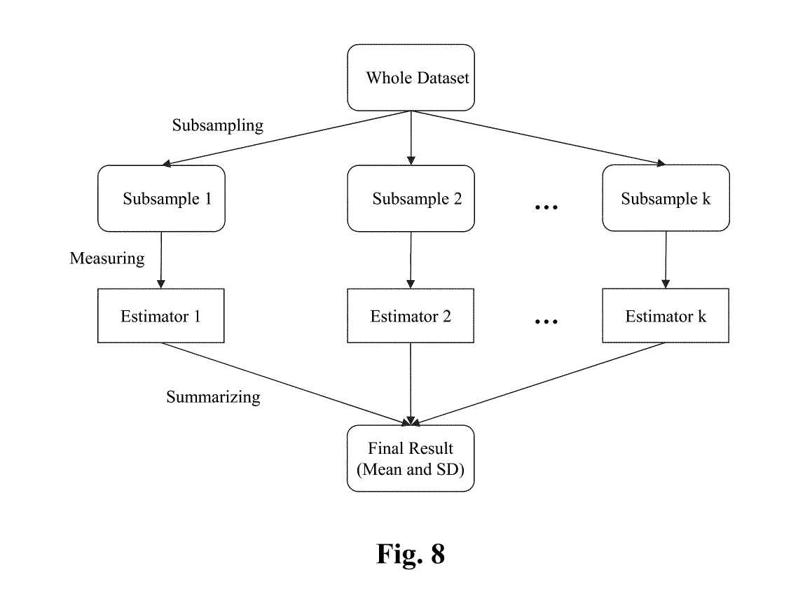

FIG. 8 is an exemplary diagram of parallel computing with subsampling in measuring user treatment effectiveness, according to an embodiment of the present teaching. The observational dataset 514, such as online ad dataset, usually contains large volumes of users, and the computation time can be substantially shortened by utilizing parallel computing. As shown in FIG. 8, the whole dataset may be divided into subsamples 1−k by subsampling. The estimations by estimators 1−k based on each of the subsamples 1−k yield measurements of ad effectiveness, and the point estimation and variation of the population-level ad effectiveness are summarized from the collected subsample estimations. The summarized results may include the mean and standard deviation from the multiple measurement results. In one example, histograms may be used to present the summarized results.

In this embodiment, the online ad dataset typically has extremely sparse conversions, and sometimes sparse exposed users. In order to better capture the pattern of the data, a novel two-stage strategy may be incorporated for propensity score and success model fitting, including a subsampling stage and a back-scaling stage. In the subsampling stage, the dataset is sampled such that the subsample contains a comparable number of control and exposed users, and a substantial number of converters. The success rates of the two groups within the subsample are estimated for example by the success rate computing module 608. The subsample success rates are then back-scaled according to the sampling rates to estimate the population-level success rates in the back-scaling stage.

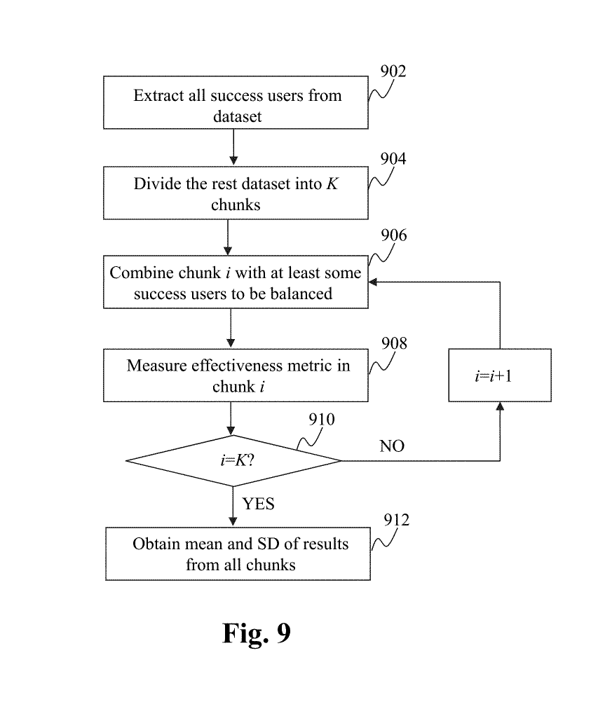

Referring now to FIG. 9, a flowchart of an exemplary process for parallel computing with subsampling in measuring user treatment effectiveness is shown, according to an embodiment of the present teaching. At 902, all the success users are extracted from dataset. At 904, the rest of the dataset is divided into K chunks. At 906, chunk i is combined with at least some success users such that the number of success users and non-success users are balanced in the sample dataset. The effectiveness metric is measured for chunk i at 908. Whether the effectiveness of all the K chunks of dataset has been measured is checked at 910, and the process is repeated from 906 for each of the remaining data chunk. Once the effectiveness of all the K chunks of dataset has been measured, at 912, the mean and standard deviation of the measurement results from all the K chunks of dataset are obtained.

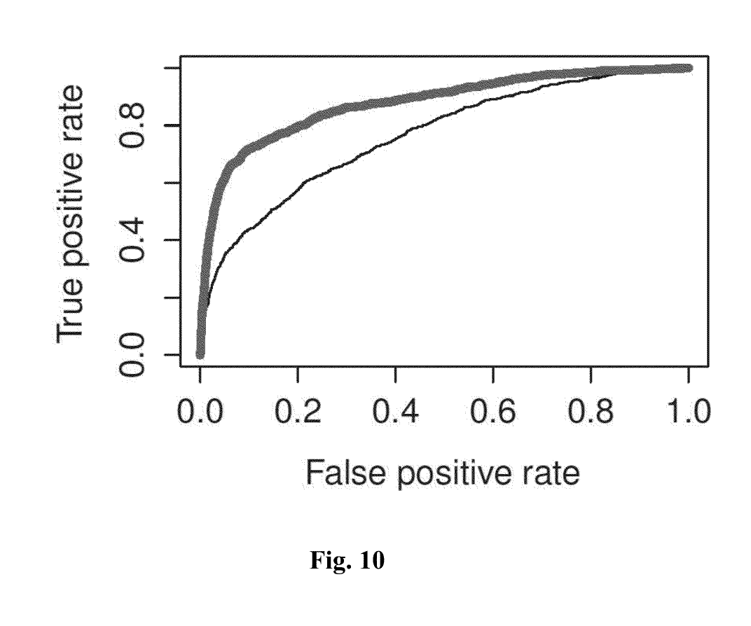

The two-stage strategy of subsampling and back-scaling improves the out-of-sample model prediction for both propensity score model and the success model. As an example, the ROC curves of the success model within the control group with (thick line) and without (thin line) subsampling are shown in FIG. 10, using real observational Internet provider campaign data, which shows uniform superiority of the subsampling strategy.

As described above, the propensity-based weighting model applied by the model fitting module 604 is aiming to balance the control and exposed groups. The conventional standardized mean difference is not robust to skewness in user feature covariate distributions. For example, in ad dataset, the user activities and features are typically heavy-tail distributed, which makes the conventional standardized mean difference test vulnerable to the heavy-tail disturbed features and outliers. The model validation engine 508 implements a weighted Mann-Whitney-Wilcoxon rank test to deal with the heavy-tailness of the observed dataset. The Mann-Whitney-Wilcoxon rank test is a nonparametric test for checking whether a sample is stochastically larger than another sample. It is known that the Mann-Whitney-Wilcoxon rank test does not assume any specific form for the distribution of the population and hence is more robust when the underlying distribution is not normal. In the user treatment effectiveness measurement engine 506, each observation is weighted according to its propensity score obtained by the probability estimating module 606. A weighted version of the Mann-Whitney-Wilcoxon rank test is derived to compare the similarity between the exposed and control users.

In this example, the Mann-Whitney-Wilcoxon test statistic is defined as follows: suppose that there are i.i.d. continuous samples Sᵢ, . . . , Sₙ, and i.i.d. samples T₁, . . . , Tₘ, define U=Σᵢ₌₁ⁿΣⱼ₌₁^{m} [symbol] (Sᵢ≦Tⱼ). Under the null hypothesis that Sᵢ's and Tⱼ's are from the same distribution,

$$u = \frac{U - μ}{σ} ,$$

with

$$μ = 𝔼 [ U ] = \frac{mn}{2} and σ = \sqrt{Var ( U )} = \sqrt{\frac{mn ( m + n + 1 )}{12}} ,$$

is asymptotically distributed as Normal(0,1). The Mann-Whitney-Wilcoxon u statistic is an approximation to ∫F(S)dG(T), where Sᵢ˜F and Tⱼ˜G. Now suppose a weight is assigned to each observation (assigning s₁, . . . , sₙ to S₁, . . . , Sₙ and t₁, . . . , tₘ to T₁, . . . Tₘ), then U⁺=Σₜ₌₁ⁿsᵢΣⱼ₌₁^{m}tⱼ [symbol] (Sᵢ≦Tⱼ). When there is no tie (i.e., there is not observation such that Sᵢ=Tⱼ),

$${μ}^{*} = 𝔼 [ {U}^{*} ] = \frac{{\sum }_{i , j} {s}_{i} {t}_{j}}{2}$$

and

$$\begin{matrix}𝔼 [ {U}^{* 2} ] = 𝔼 [ \begin{matrix}{\sum }_{i = k , j = l} {s}_{i}^{2} {t}_{j}^{2} 𝕀 ( {S}_{i} \leq {T}_{j} ) + \\ {\sum }_{i = k , j \neq l} {s}_{i}^{2} {t}_{j} {t}_{l} 𝕀 ( {S}_{i} \leq {T}_{j} ) 𝕀 ( {S}_{i} \leq {T}_{i} ) + \\ {\sum }_{i \neq k , j = l} {s}_{i} {s}_{k} {t}_{j}^{2} 𝕀 ( {S}_{i} \leq {T}_{j} ) 𝕀 ( {S}_{k} \leq {T}_{j} ) + \\ {\sum }_{i \neq k , j \neq l} {s}_{i} {s}_{k} {t}_{j} {t}_{l} 𝕀 ( {S}_{i} \leq {T}_{j} ) 𝕀 ( {S}_{k} \leq {T}_{l} )\end{matrix} ] \\ = \frac{1}{2} {\sum }_{i = k , j = l} {s}_{i}^{2} {t}_{j}^{2} + \frac{1}{3} {\sum }_{i = k , j \neq l} {s}_{i}^{2} {t}_{j} {t}_{l} + \frac{1}{3} {\sum }_{i \neq k , j = l} {s}_{i} {s}_{k} {t}_{j}^{2} + \\ \frac{1}{4} {\sum }_{i \neq k , j \neq l} {s}_{i} {s}_{k} {t}_{j} {t}_{l} ,\end{matrix} \qquad ( 13 )$$

which yields

$$\begin{matrix}{σ}^{* 2} = 𝔼 [ {U}^{* 2} ] - {𝔼 [ {U}^{*} ]}^{2} \\ = \frac{1}{4} {\sum }_{i = k , j = l} {s}_{i}^{2} {t}_{j}^{2} + \frac{1}{12} {\sum }_{i = k , j \neq l} {s}_{i}^{2} {t}_{j} {t}_{l} + \frac{1}{12} {\sum }_{i \neq k , j = l} {s}_{i} {s}_{k} {t}_{j}^{2} \\ = \frac{1}{12} [ {\sum }_{i = k , j = l} {s}_{i}^{2} {t}_{j}^{2} + {\sum }_{j , l , i = k} {s}_{i}^{2} {t}_{j} {t}_{l} + {\sum }_{i , k , j = l} {s}_{i} {s}_{k} {t}_{j}^{2} ] .\end{matrix} \qquad ( 14 )$$

### Hence

$${u}^{*} = \frac{{U}^{*} - {μ}^{*}}{{σ}^{*}} ∼ Normal ( 0 , 1 ) .$$

One can then compare the calculated u* with the standard normal distribution to test the null hypothesis H₀:u*=0 versus alternative hypothesis H₀:u*≠0. If s₁= . . . =sₙ=t₁= . . . =tₘ=1, that is if the samples are equally weighted then

$${μ}^{*} = \frac{mn}{2} and$$

$${σ}^{* 2} = \frac{1}{4} ( mn ) + \frac{1}{12} nm ( m - 1 ) + \frac{1}{12} mn ( n - 1 ) = \frac{mn ( m + n + 1 )}{12} ,$$

as expected.

In another example, now suppose the two samples have ties. Again, the test statistic is

$${u}^{*} = \frac{{U}^{*} - {μ}^{*}}{{σ}^{*}} .$$

The estimation u* keeps the same. σ*² is derived as follows. For distinct i, j, and l,

1=P(Sᵢ<Tⱼ<Tᵢ)+P(Sᵢ<Tᵢ<Tⱼ)+P(Tⱼ<Sᵢ<Tᵢ)+P(Tⱼ<Tᵢ<Sᵢ)+P(Tᵢ<Sᵢ<Tⱼ)+P(Tᵢ<Tⱼ<Sᵢ)+P(Sᵢ<Tⱼ=Tᵢ)+P(Sᵢ<Tⱼ=Tᵢ)+P(Tⱼ<Sᵢ=Tᵢ)+P(Tⱼ>Sᵢ=Tᵢ)+P(Tᵢ<Sᵢ=Tⱼ)+P(Tᵢ>Sᵢ=Tⱼ),

and

P(Sᵢ<Tⱼ<Tᵢ)=P(Sᵢ<Tₗ<Tⱼ)=P(Tⱼ<Sᵢ<Tₗ)=P(Tⱼ<Tₗ<Sᵢ)=P(Tₗ<Sᵢ<Tⱼ)=P(Tₗ<Tⱼ<Sᵢ), P(Sᵢ<Tⱼ=Tₗ)=P(Sᵢ>Tⱼ=Tₗ)=P(Tⱼ<Sᵢ=Tₗ)=P(Tⱼ>Sᵢ=Tₗ)=P(Tₗ<Sᵢ=Tⱼ)=P(Tₗ>Sᵢ=Tⱼ).

### Hence,

$${U}^{* 2} = {\sum }_{i = k , j = l} {s}_{i}^{2} {t}_{j}^{2} [ 𝕀 ( {S}_{i} < {T}_{j} ) + \frac{1}{4} 𝕀 ( {S}_{i} = {T}_{j} ) ] + {\sum }_{i = k , j \neq l} {s}_{i}^{2} {t}_{j} {t}_{l} [ 𝕀 ( {S}_{i} < {T}_{j} ) 𝕀 ( {S}_{i} < {T}_{l} ) + \frac{1}{4} 𝕀 ( {S}_{i} = {T}_{j} ) 𝕀 ( {S}_{i} = {T}_{l} ) + \frac{1}{2} 𝕀 ( {S}_{i} < {T}_{j} ) 𝕀 ( {S}_{i} = {T}_{l} ) + \frac{1}{2} 𝕀 ( {S}_{i} = {T}_{j} ) 𝕀 ( {S}_{i} < {T}_{l} ) ] + {\sum }_{i \neq k , j = l} {s}_{i} {s}_{k} {t}_{j}^{2} [ 𝕀 ( {S}_{i} < {T}_{j} ) 𝕀 ( {S}_{k} < {T}_{j} ) + \frac{1}{4} 𝕀 ( {S}_{i} = {T}_{j} ) 𝕀 ( {S}_{k} = {T}_{j} ) + \frac{1}{2} 𝕀 ( {S}_{i} < {T}_{j} ) 𝕀 ( {S}_{k} = {T}_{j} ) ++ \frac{1}{2} 𝕀 ( {S}_{i} = {T}_{j} ) 𝕀 ( {S}_{k} < {T}_{j} ) ] + {\sum }_{i \neq k , j \neq l} {s}_{i} {s}_{k} {t}_{j} {t}_{l} [ 𝕀 ( {S}_{i} < {T}_{j} ) + \frac{1}{2} 𝕀 ( {S}_{i} = {T}_{j} ) ] [ 𝕀 ( {S}_{k} < {T}_{l} ) + \frac{1}{2} 𝕀 ( {S}_{k} = {T}_{l} ) ] .$$

### Thus,

$$𝔼 [ {U}^{* 2} ] = \frac{1}{2} {\sum }_{i = k , j = l} {s}_{i}^{2} {t}_{j}^{2} + \frac{1}{3} {\sum }_{i = k , j \neq l} {s}_{i}^{2} {t}_{j} {t}_{l} + \frac{1}{3} {\sum }_{i \neq k , j = l} {s}_{i} {s}_{k} {t}_{j}^{2} + \frac{1}{4} {\sum }_{i \neq k , j \neq l} {s}_{i} {s}_{k} {t}_{j} {t}_{l} - \frac{1}{4} {\sum }_{i = k , j = l} {s}_{i}^{2} {t}_{j}^{2} P ( {S}_{i} = {T}_{j} ) - \frac{1}{12} {\sum }_{i = k , j \neq l} {s}_{i}^{2} {t}_{j} {t}_{l} P ( {S}_{i} = {T}_{j} = {T}_{l} ) - \frac{1}{12} {\sum }_{i \neq k , j = l} {s}_{i} {s}_{k} {t}_{j}^{2} P ( {S}_{i} = {S}_{k} = {T}_{j} ) .$$

### So,

$$\begin{matrix}{σ}^{* 2} = 𝔼 [ {U}^{* 2} ] - {𝔼 [ {U}^{*} ]}^{2} \\ = \frac{1}{12} [ {\sum }_{i = k , j = l} {s}_{i}^{2} {t}_{j}^{2} + {\sum }_{j , l , i = k} {s}_{i}^{2} {t}_{j} {t}_{l} + {\sum }_{i , k , j = l} {s}_{i} {s}_{k} {t}_{j}^{2} ] - \\ \frac{1}{12} [ \begin{matrix}{\sum }_{i = k , j = l} {s}_{i}^{2} {t}_{j}^{2} P ( {S}_{i} = {T}_{j} ) - \\ {\sum }_{i = k , j , l} {s}_{i}^{2} {t}_{j} {t}_{l} P ( {S}_{i} = {T}_{j} = {T}_{l} ) - \\ {\sum }_{i , k , j = l} {s}_{i} {s}_{k} {t}_{j}^{2} P ( {S}_{i} = {S}_{k} = {T}_{j} )\end{matrix} ] .\end{matrix}$$

Now applying the weighted Mann-Whitney-Wilcoxon rank test to the IPW approach described above. Again suppose each of the users is assigned weight ωᵢ according to the probability estimating module 606. For each of the selected user features m (indicated by xᵢₘ for user i), when there is no ties, the test statistic is calculated as

$${u}^{*} = \frac{{U}^{*} - {μ}^{*}}{{σ}^{*}} ∼ Normal ( 0 , 1 ) ,$$

where

$${U}^{*} = {\sum }_{i = 1}^{N} {w}_{i} {\sum }_{j = 1}^{N} {w}_{j} 𝕀 ( {x}_{im} < {x}_{jm} ) {z}_{i} ( 1 - {z}_{j} ) ;$$

$${μ}^{*} = 𝔼 [ {U}^{*} ] = \frac{{\sum }_{i , j} {w}_{i} {w}_{j} {z}_{i} ( 1 - {z}_{j}}{2} ;$$

$${σ}^{* 2} = \frac{1}{12} [ {\sum }_{i , j} {s}_{i}^{2} {s}_{j}^{2} {z}_{i} ( 1 - {z}_{j} ) + {\sum }_{i , j , l} {s}_{i}^{2} {t}_{j} {t}_{l} {z}_{i} ( 1 - {z}_{j} ) ( 1 - {z}_{l} ) + {\sum }_{i , k , j} {s}_{i} {s}_{k} {t}_{j}^{2} {z}_{i} {z}_{k} ( 1 - {z}_{j} ) ] .$$

When there are ties, σ*² is estimated as

$${σ}^{* 2} = \frac{1}{12} [ {\sum }_{i , j} {w}_{i}^{2} {w}_{j}^{2} {z}_{i} ( 1 - {z}_{j} ) + {\sum }_{i , j , l} {w}_{i}^{2} {w}_{j} {w}_{l} {z}_{i} ( 1 - {z}_{j} ) ( 1 - {z}_{l} ) + {\sum }_{i , k , j} {w}_{i} {w}_{k} {w}_{j}^{2} {z}_{i} {z}_{k} ( 1 - {z}_{j} ) ] - \frac{1}{12} [ {\sum }_{i , j} {w}_{i}^{2} {w}_{j}^{2} {z}_{i} ( 1 - {z}_{j} ) P ( {x}_{im} = {x}_{jm} ) + {\sum }_{i , j , l} {w}_{i}^{2} {w}_{j} {w}_{l} P ( {x}_{im} = {x}_{jm} = {x}_{lm} ) {z}_{i} ( 1 - {z}_{j} ) ( 1 - {z}_{l} ) + {\sum }_{i , k , j} {w}_{i} {w}_{k} {w}_{j}^{2} P ( {x}_{im} = {x}_{km} = {x}_{jm} ) {z}_{i} {z}_{k} ( 1 - {z}_{j} ) ] , .$$

The reduction of the absolute value of the test statistic u* after IPW indicates the balancing effect of the weighting.

In general, a smaller u* means that the control and exposed groups are more balanced. For example, if u* is reduced after the IPW weighting, it means that the IPW weighting model works to balance the control and exposed groups. For the test H₀:u*=0 versus alternative hypothesis H₀:u*≠0, if the absolute value of u* is larger than the absolute value of φ⁻¹(a/2), the null hypothesis is rejected, which means that the control and exposed groups are significantly different under a significance level. a can be chosen arbitrarily, and usually it can be chosen as 0.05. φ is the cumulative density function of the standard normal distribution.

In one example, the model validation engine 508 implementing the weighted Mann-Whitney-Wilcoxon rank is tested with a simulation data set of 20,000 users. The simulated data set includes heavy-tail distributed features with exponential normal distribution. Since the features are generated with continuous distribution, weighted Mann-Whitney-Wilcoxon rank with no tie is used in this simulation. For each of the user features, the propensity of exposure and success probability is generated with GBT. It is assumed that no causal effect between the exposure indicator and success rates. The simulated dataset is fitted by the propensity score model fitting unit 616, and the user feature covariate balancing is checked with the weighted Mann-Whitney-Wilcoxon rank test.

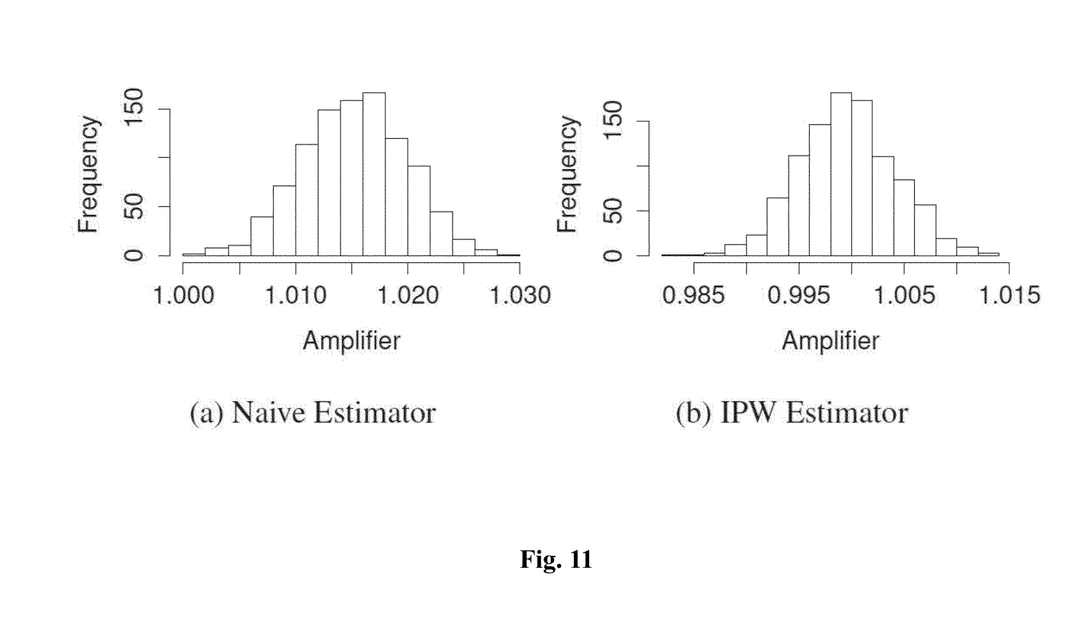

The histograms of naive amplifier and the adjusted amplifier obtained by the user treatment effectiveness measurement engine 506 are shown in FIG. 11. While the naive estimator is significantly larger than 1, the weighted estimator (results from the user treatment effectiveness measurement engine 506) are centered at 1 with symmetric shape. It is apparent that the weighting successfully captures the bias of the user features. In such cases, the weighted features of the control and exposed groups are supposed to be balanced. However, as stated before, the conventional standard mean difference test is vulnerable with heavy-tail distribution. The test statistics of the standard mean difference test are computed for each feature, whose absolute value ranges from 0.28 to 3.67. Setting the significance level of the hypothesis test to be 0.05 and hence the cut-off value of the test statistics to be 2, 30% of the feature differences are tested to be significantly different than 0. In contrast, with the weighted Mann-Whitney-Wilcoxon rank test implemented by the model validation engine 508, the absolute value of the mean test statistics ranges from 0.43 to 1.96. Under the 0.05 significance level, all of the features pass the rank test. The simulation shows that the weighted Mann-Whitney-Wilcoxon rank test is robust when the distribution of user features is heavily skewed, while the conversional test fails to capture the balancing effect of IPW.

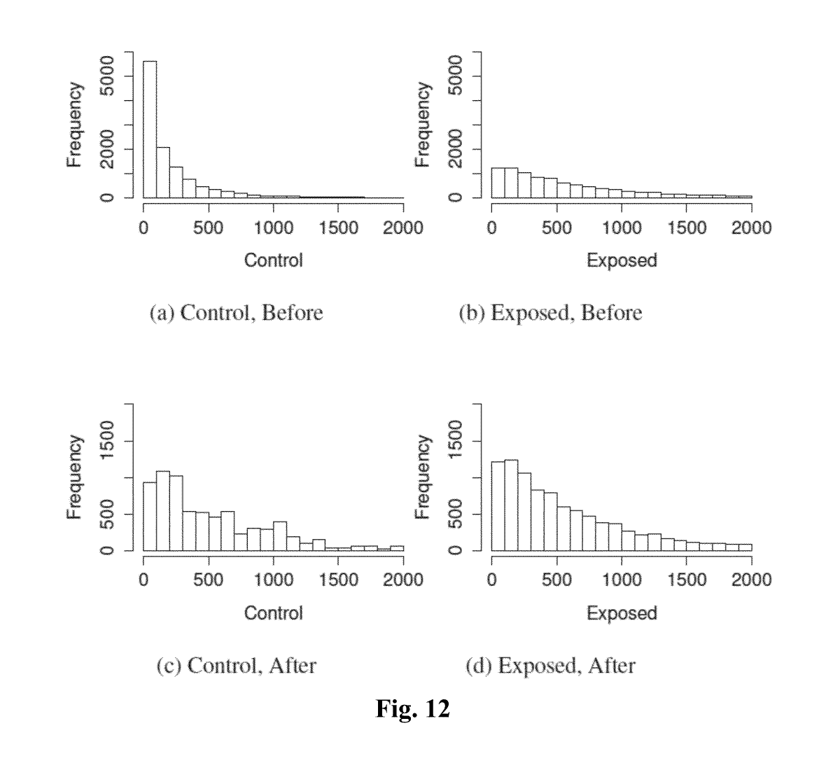

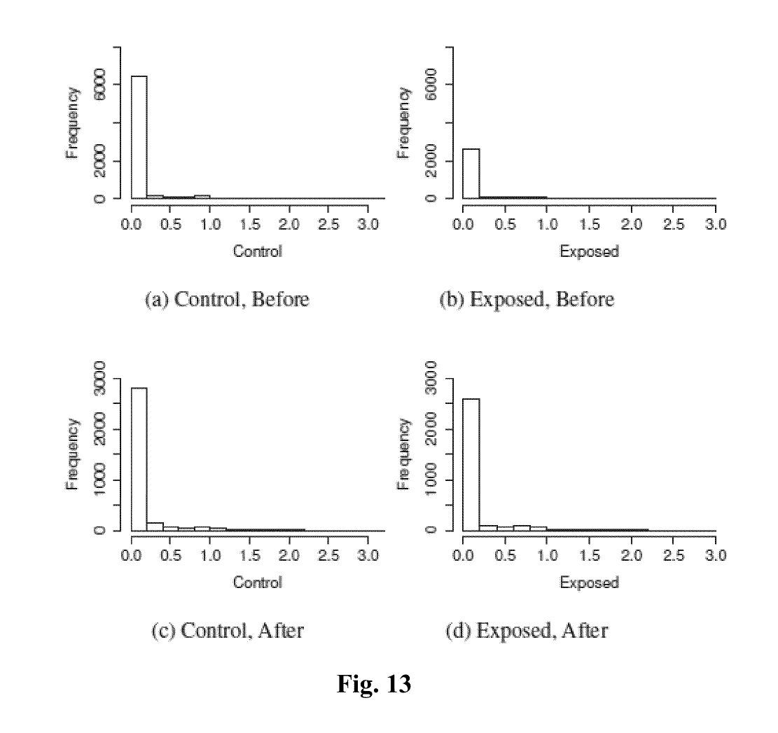

The balancing effect of the propensity-based weighting by the user treatment effectiveness measurement engine 506 is verified with the weighted Mann-Whitney-Wilcoxon rank test by the model validation engine 508 using two real datasets: the auto insurance marketing campaign dataset and the Internet service providers marketing campaign dataset. For the most relevant 10 user features, the percentage reduction ranges from 50% to 92.3%, which indicates that the weighting significantly balanced the relevant user features. FIG. 12 depicts exemplary histograms showing, as a single user feature, the network activities change before and after the weighting for the control and treatment groups in the Internet service providers marketing campaign dataset. The figure shows a significant improvement in the balance of network activity. FIG. 13 depicts exemplary histograms showing, as another user feature, the auto purchase intention changes before and after the weighting for the control and treatment groups in the auto insurance marketing campaign dataset. Similarly, the figure shows a significant improvement in the balance of auto purchase intention. These results are consistent with the rank test results by the model validation engine 508.

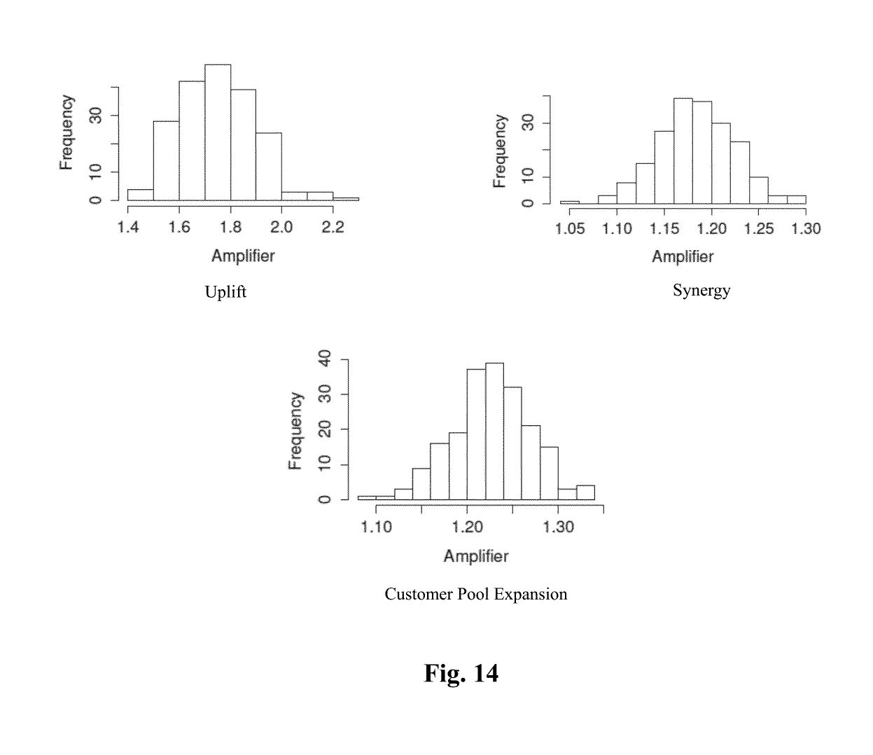

FIG. 14 depicts exemplary histograms showing the uplift, synergy, and customer pool expansion effects. In one example of measuring the uplift effect, a marketing campaign of a major Internet provider company with only banner ads is analyzed by the system 500. The effectiveness of the banner ads comparing to no ad exposure is measured by the user treatment effectiveness measurement engine 506. The success action is online quotes. The treatment/exposed group is defined as the users who were exposed to the banner ads, while the control group users were not exposed to ads. The dataset contains about 18.7 million users with merely 0.3 million exposed user and 1.9 thousands conversions. This case involves not only sparse successes, but also relatively sparse exposed observations. Hence the subsampling-back scaling strategy includes importance sampling with large sampling rates for the exposed users and converters. In this example, the naive ratio/amplifier summarized from the whole dataset is 2.52. With the user treatment effectiveness measurement engine 506, a population level TTE ratio/amplifier of 1.751, i.e. the ads lifting the conversion rate by 75.1%, is obtained. The collected amplifier estimations from each subsampled data chunk have standard deviation 0.137, which suggests small variation in the results for different sub-datasets. The histogram (top left) in FIG. 14 of the subsample amplifiers shows good robustness of the results. It also shows symmetry and uni-mode, which suggests that the average of the amplifiers from each chunk is a good representation of the amplifier of the population.

In another example of measuring the synergy effect, joint effect of two advertising strategies on a marketing campaign of a major auto insurance company is measured. The two strategies are a website takeover and a direct response banner ad. The effectiveness of the website takeover on top of the direct response banner ad is measured. The treatment/exposed group is defined as the users who were exposed to both the website takeover and the banner ads, while the control group users were only exposed to the banner ads. The auto insurance company dataset contains approximately 2.8 million users with 11.7 thousand converters. The naive ratio/amplifier is 0.94, and the estimated TTE ratio/amplifier is 1.184, i.e. the webpage takeover lifting the conversion rate by 18.4% on top of the direct response banner ad. The result is shown in the histogram (top right) in FIG. 14. This shows that naive amplifier underestimates the amplification effect of the two advertising strategies, but in fact, users who were exposed to both strategies are 1.184 times more likely to convert.

In still another example of measuring customer pool expansion effect, the reach extension effect of the upper-funnel placement (website takeover) on the lower-funnel placement (direct response) is measured for the same marketing campaign dataset of the auto insurance company. How much more likely the users mitigate into interest segments that can be targeted by the direct response campaign after being exposed to the website takeover campaign. The success metric is the indicator representing whether or not each user is included in the targeting pool of the lower-funnel placement. The exposure is defined as exposure to the upper-funnel ad impressions. The naive ratio/amplifier is 1.80, and the estimated TTE ratio/amplifier is 1.23. Thus, the webpage takeover brings 23% more customers to the direct response banner ad. The result is shown in the histogram (bottom) in FIG. 14.

In the above-mentioned examples, the analysis reveals positive ad impact on the uplift, synergy, and customer pool expansion aspects. However, the change of ratio/amplifier after causal inference can be positive or negative, which requires further interpretation from business point of view. The result interpretation engine 510 may compare the raw ratio/amplifier with the adjusted ratio/amplifier after causal inference. Note that the propensity score model corrects the ratio/amplifier by eliminating the effect of user features, and hence the change of the ratio/amplifier reveals the nature of the ad placement: either it is doing “smart cheating” and reaching users who would convert even without the ad, or reaching users who would not convert without the ad. There are two possible scenarios may be interpreted by the result interpretation engine 510.

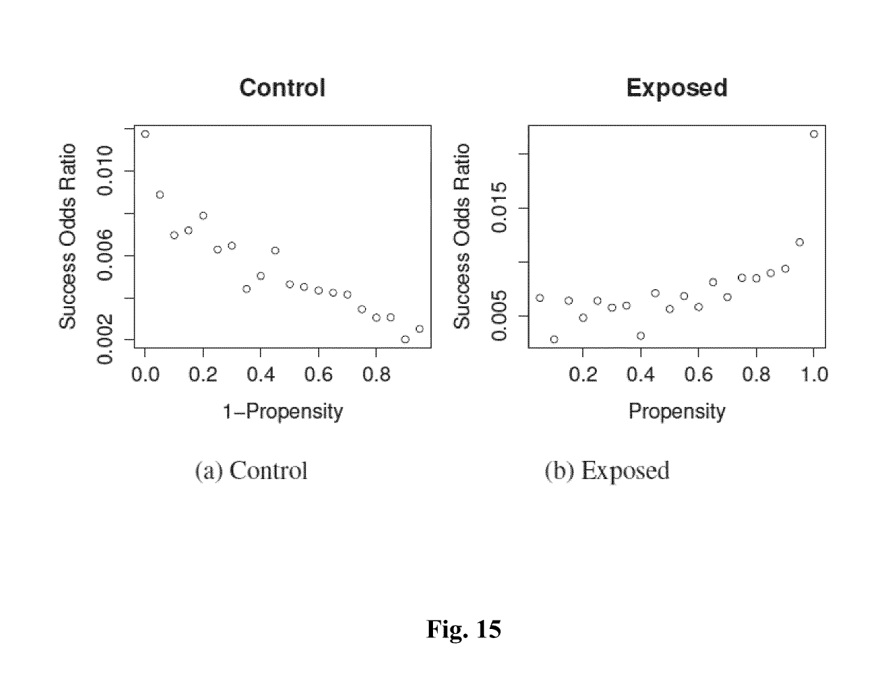

The first scenario is that the ratio/amplifier decreases after adjustment. This means the confounding effect of user features inflates the raw ratio/amplifier, and hence the exposed group is doing “smart cheating,” namely, the exposed group contains more users who are likely to convert even without ad exposure. In the Internet provider company campaign example mentioned above, the ratio/amplifier shrinks after adjustment. To further investigate the users in the control and exposed groups, the success odds ratios of both groups along with the probability belonging to the corresponding group are shown in FIG. 15. The increasing trend in FIG. 15(b) shows that the exposed group tends to contain users who are more likely to convert, and the control group the opposite. Hence the placement is doing “smart cheating,” and the causal inference eliminates such effect by shrinking the ratio/amplifier, as expected.

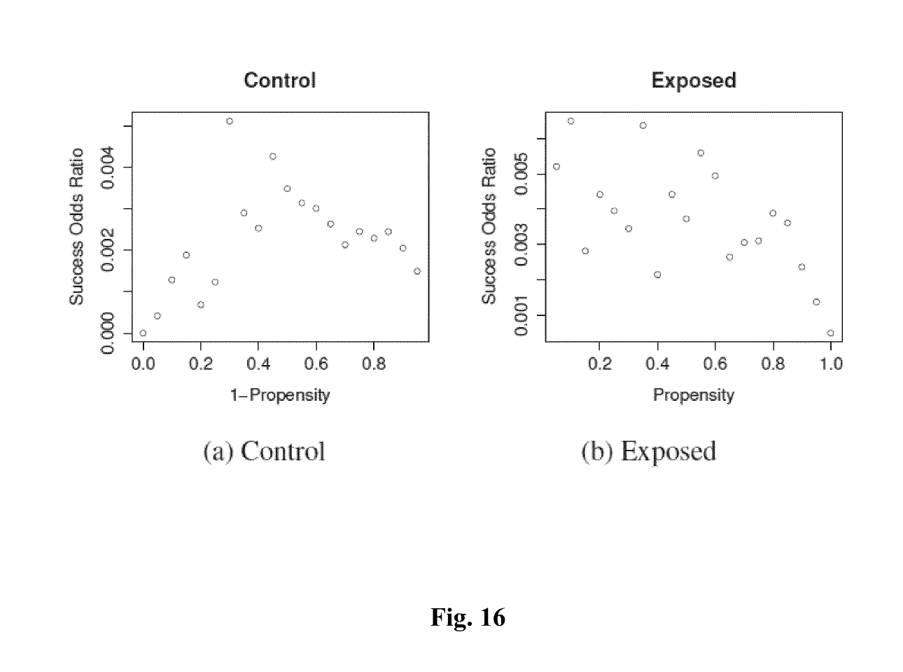

The second scenario is that the ratio/amplifier is enlarged after adjustment. This means that the confounding effect of user features deflates the raw ratio/amplifier, and hence the exposed group is reaching “hard users,” namely, the exposed group contains more users who are less likely to convert without ad exposure. In an example of a marketing campaign of a phone system with only banner ads, the effectiveness of the banner ads comparing to no ad exposure is measured by the user treatment effectiveness measurement engine 506. There are about 0.2 million exposed users and 1.2 million control users, with 2,000 converters. The naive ratio/amplifier is 0.51, and the population level TTE ratio/amplifier is 1.27. The raw data implies negative uplift effect of the banner ads, while after correcting the biases in the user features of the control and exposed groups, the effect is positive, i.e. the ad lifting the conversion rate by 27%. In this example, the ratio/amplifier is about twice after adjustment. The success odds ratios of both groups along with the probability belonging to the corresponding group are shown in FIG. 16. The declining trend FIG. 16(b) shows that the exposed group tends to include users who are less likely to convert, i.e. “hard users,” and the control group has more “easy users.” Hence the causal inference eliminates such effect, and brings back the true impact of ads.

In some embodiments, there are multiple advertising treatments that require a fair comparison. For example ads presented with multiple strategies (e.g. text, video, and figure), or from multiple serving pipelines (e.g. banner, search, and email). In these embodiments, it is straightforward to generalize the method and system in the present teaching to multiple treatments situation, where the treatment indicator zᵢ=t for user i where t=1, 2, . . . , T indicates the treatment the user received. One step is to modify the formula to estimate the success rate of each treatment group. In the IPW approach, Equations (3) and (4) need to be changed to

$${r}_{ipw , t} = \frac{1}{N} {\sum }_{i} {I}_{{z}_{i} = t} {y}_{i} / {\hat{p}}_{i}^{t} , \qquad ( 15 )$$

where \hat{p}ᵢ^{t} is the estimated probability for user i to be exposed to treatment t, and r_{ipw,t} is the estimated success rate for users of treatment t. One way to estimate \hat{p}ᵢ^{t} for multiple treatments is multinomial logistic regression (MLR). Other approaches, such as GBT, may also be applied. For the DR approach, Equations (7)-(10) need to be changed to

$$\begin{matrix}{δ}_{1 , t} = \frac{{I}_{{z}_{i} = t} {y}_{i} - {\hat{m}}_{i}^{t} ( {I}_{{z}_{i} = t} - {\hat{p}}_{i}^{t} )}{{\hat{p}}_{i}^{t}} , & ( 16 ) \\ {r}_{dr , t} = \frac{1}{N} {\sum }_{i} {δ}_{1 , t} , & ( 17 )\end{matrix}$$

where \hat{m}ᵢ^{t} is the estimated conversion probability for user i if the user i receives treatment t, and r_{dr,t} is the estimated success rate under treatment t.

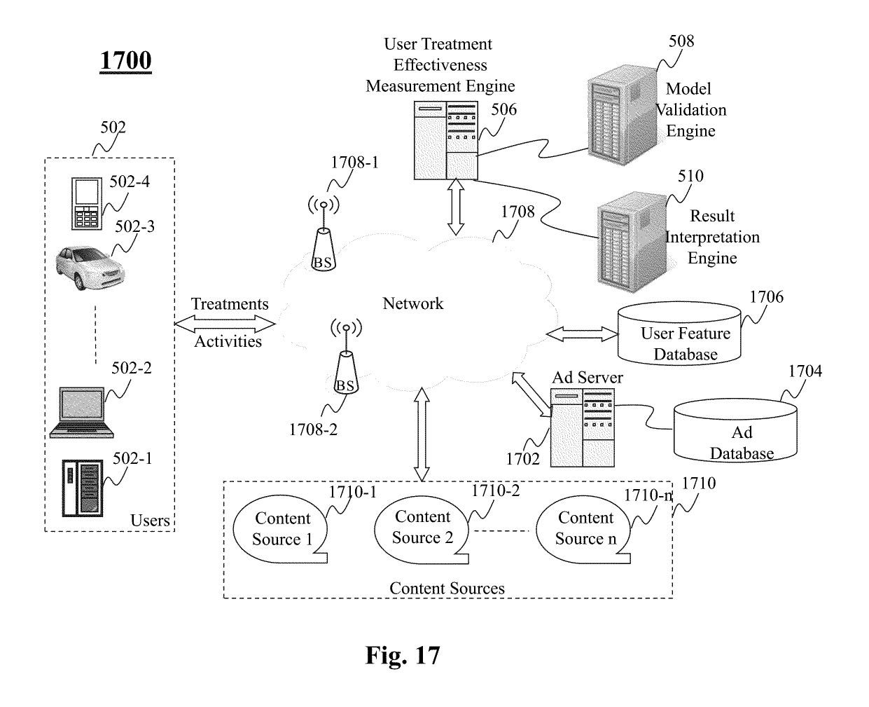

FIG. 17 depicts an exemplary embodiment of a networked environment in which user treatment effectiveness measurement is applied, according to an embodiment of the present teaching. In FIG. 17, the exemplary networked environment 1700 includes the user treatment effectiveness measurement engine 506, the model validation engine 508, the result interpretation engine 510, users 502, an ad server 1702, an ad database 1704, a user feature database 1706, a network 1708, and content sources 1710. The network 1708 may be a single network or a combination of different networks. For example, the network 1708 may be a local area network (LAN), a wide area network (WAN), a public network, a private network, a proprietary network, a Public Telephone Switched Network (PSTN), the Internet, a wireless network, a virtual network, or any combination thereof. The network 1708 may also include various network access points, e.g., wired or wireless access points such as base stations or Internet exchange points 1708-1, . . . , 1708-2, through which a data source may connect to the network 1708 in order to transmit information via the network 1708.

Users 502 may be of different types such as users connected to the network 1708 via desktop computers 502-1, laptop computers 502-2, a built-in device in a motor vehicle 502-3, or a mobile device 502-4. Activities and treatments of the users 502 may be monitored and collected by the user treatment effectiveness measurement engine 506. In addition to user activity data, user features may be also collected and stored in the user feature database 1706. In one example, the user features may be captured in a predetermined length of time period e.g., 30 days, before the user treatment. In examples related to ad exposures and ad conversions, the ad server 1702 in conjunction with the ad database 1704 are used for providing online ads to the users, such as website takeovers, banner ads, etc. The content sources 1710 include multiple content sources 1710-1, 1710-2, . . . , 1710-n, such as vertical content sources (e.g., shopping, local, news, finance, etc.). A content source may correspond to a website hosted by an entity, whether an individual, a business, or an organization such as USPTO.gov, a content provider such as cnn.com and Yahoo.com, a social network website such as Facebook.com, or a content feed source such as tweeter or blogs. As described above, the user treatments effectiveness measurement is not limited to ad campaigns. In some examples, various strategies on user engagement metrics may be applied by the user treatment effectiveness measurement engine 506 in a similar manner with respect to user interactions with any content provided by the content sources 1710.

Information related to treatments, activities, and features of each user in the treatment and control groups is obtained by the user treatment effectiveness measurement engine 506 for providing effectiveness metrics indicating various causal effects (e.g., uplift, synergy, or customer pool expansion) as described above in details. The models used by the user treatment effectiveness measurement engine 506, e.g., the propensity score models for eliminating user features' bias, are validated by the model validation engine 508. The results can be interpreted from business point of view by the result interpretation engine 510. In this embodiment, the model validation engine 508 and result interpretation engine 510 serve as backend systems of the user treatment effectiveness measurement engine 506. It is understood that in other examples, the model validation engine 508 and/or the result interpretation engine 510 may be standalone systems for providing independent services.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

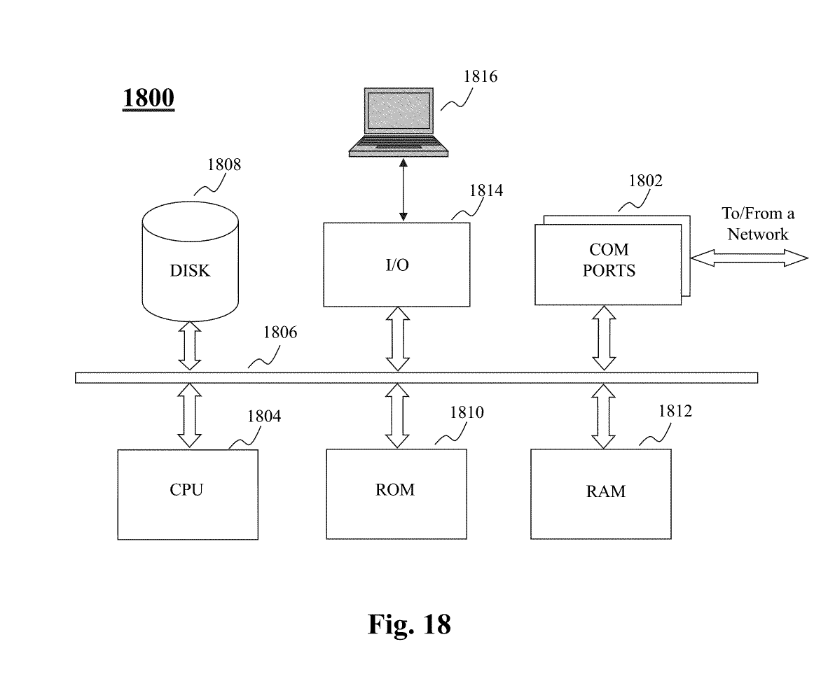

FIG. 18 depicts a general computer architecture on which the present teaching can be implemented and has a functional block diagram illustration of a computer hardware platform that includes user interface elements. The computer may be a general-purpose computer or a special purpose computer. This computer 1800 can be used to implement any components of the user treatment effectiveness measurement architecture as described herein. Different components of the systems disclosed in the present teaching can all be implemented on one or more computers such as computer 1800, via its hardware, software program, firmware, or a combination thereof. Although only one such computer is shown, for convenience, the computer functions relating to user treatment effectiveness measurement may be implemented in a distributed fashion on a number of similar platforms, to distribute the processing load.

The computer 1800, for example, includes COM ports 1802 connected to and from a network connected thereto to facilitate data communications. The computer 1800 also includes a CPU 1804, in the form of one or more processors, for executing program instructions. The exemplary computer platform includes an internal communication bus 1806, program storage and data storage of different forms, e.g., disk 1808, read only memory (ROM) 1810, or random access memory (RAM) 1812, for various data files to be processed and/or communicated by the computer, as well as possibly program instructions to be executed by the CPU 1804. The computer 1800 also includes an I/O component 1814, supporting input/output flows between the computer and other components therein such as user interface elements 1816. The computer 1800 may also receive programming and data via network communications.

Hence, aspects of the methods of user treatment effectiveness measurement, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the units of the host and the client nodes as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, implemented on at least one computing device each of which has at least one processor, storage, and a communication platform connected to a network for measuring effectiveness of user treatment, the method comprising:
receiving first information related to activities of each user in a first user set in response to a first treatment;
receiving second information related to activities of each user in a second user set in response to a second treatment;
obtaining a first model with respect to one or more features based on the first and second information, wherein each user in the first and second user sets is associated with the one or more features;
estimating a weighing factor for each user in the first and second user sets based on the first model and the one or more features of the respective user;
computing a first success rate of the first user set based, at least in part, on the first information and the weighting factors for each user in the first user set;
computing a second success rate of the second user set based, at least in part, on the second information and the weighting factors for each user in the second user set; and
measuring a metric of effectiveness of the first treatment compared with the second treatment based on the first and second success rates.

2. The method of claim 1, wherein the weighting factor relates to probability of exposing the respective user to the first treatment with respect to the one or more features.

3. The method of claim 1, further comprising:
obtaining a second model with respect to the one or more features based on the first and second information; and
estimating an adjusting factor for each user in the first and second user sets based on the second model and the one or more features of the respective user, the adjusting factor relating to probability of performing an effective activity by the respective user with respect to the one or more features, wherein
the first and second success rates are computed based, at least in part, on the adjusting factors for each user in the first and second user sets, respectively.

4. The method of claim 1, wherein the first treatment includes exposure of an advertisement, and the second treatment includes non-exposure of the advertisement.

5. The method of claim 1, wherein the first treatment includes exposure of a plurality of advertisements, and the second treatment includes exposure of only some of the plurality of advertisements.

6. The method of claim 1, wherein the user activities of each user in the first and second user sets include at least one of an advertisement conversion and a tendency towards advertisement conversion.

7. The method of claim 1, wherein the metric of effectiveness includes at least one of a difference between the first and second success rates and a ratio of the first success rate over the second success rate.

8. A system having at least one processor storage, and a communication platform for measuring effectiveness of user treatment, the system comprising:
a user activity data collecting module configured to receive first information related to activities of each user in a first user set in response to a first treatment and second information related to activities of each user in a second user set in response to a second treatment;
a model fitting module configured to obtain a first model with respect to one or more features based on the first and second information, wherein each user in the first and second user sets is associated with the one or more features;
a probability estimating module configured to estimate a weighing factor for each user in the first and second user sets based on the first model and the one or more features of the respective user;
a success rate computing module configured to compute a first success rate of the first user set based, at least in part, on the first information and the weighting factors for each user in the first user set and a second success rate of the second user set based, at least in part, on the second information and the weighting factors for each user in the second user set; and
a metric measuring module configured to measure a metric of effectiveness of the first treatment compared with the second treatment based on the first and second success rates.

9. The system of claim 8, wherein the weighting factor relates to probability of exposing the respective user to the first treatment with respect to the one or more features.

10. The system of claim 8, wherein
the model fitting module is further configured to obtain a second model with respect to the one or more features based on the first and second information;
the probability estimating module is further configured to estimate an adjusting factor for each user in the first and second user sets based on the second model and the one or more features of the respective user, the adjusting factor relating to probability of performing an effective activity by the respective user with respect to the one or more features; and
the success rate computing module is further configured compute the first and second success rates based, at least in part, on the adjusting factors for each user in the first and second user sets, respectively.

11. The system of claim 8, wherein the first treatment includes exposure of an advertisement, and the second treatment includes non-exposure of the advertisement.

12. The system of claim 8, wherein the first treatment includes exposure of a plurality of advertisements, and the second treatment includes exposure of only some of the plurality of advertisements.

13. The system of claim 8, wherein the user activities of each user in the first and second user sets include at least one of an advertisement conversion and a tendency towards advertisement conversion.

14. The system of claim 8, wherein the metric of effectiveness includes at least one of a difference between the first and second success rates and a ratio of the first success rate over the second success rate.

15. A non-transitory machine-readable medium having information recorded thereon for measuring effectiveness of user treatment, wherein the information, when read by the machine, causes the machine to perform the following:
receiving first information related to activities of each user in a first user set in response to a first treatment;
receiving second information related to activities of each user in a second user set in response to a second treatment;
obtaining a first model with respect to one or more features based on the first and second information, wherein each user in the first and second user sets is associated with the one or more features;
estimating a weighing factor for each user in the first and second user sets based on the first model and the one or more features of the respective user;
computing a first success rate of the first user set based, at least in part, on the first information and the weighting factors for each user in the first user set;
computing a second success rate of the second user set based, at least in part, on the second information and the weighting factors for each user in the second user set; and
measuring a metric of effectiveness of the first treatment compared with the second treatment based on the first and second success rates.

16. The medium of claim 15, wherein the weighting factor relates to probability of exposing the respective user to the first treatment with respect to the one or more features.

17. The medium of claim 15, further comprising:
obtaining a second model with respect to the one or more features based on the first and second information; and
estimating an adjusting factor for each user in the first and second user sets based on the second model and the one or more features of the respective user, the adjusting factor relating to probability of performing an effective activity by the respective user with respect to the one or more features, wherein
the first and second success rates are computed based, at least in part, on the adjusting factors for each user in the first and second user sets, respectively.

18. The medium of claim 15, wherein the first treatment includes exposure of an advertisement, and the second treatment includes non-exposure of the advertisement.

19. The medium of claim 15, wherein the first treatment includes exposure of a plurality of advertisements, and the second treatment includes exposure of only some of the plurality of advertisements.

20. The medium of claim 15, wherein the user activities of each user in the first and second user sets include at least one of an advertisement conversion and a tendency towards advertisement conversion.
